(19) United States
(12) Patent Application Publication
(10) Pub. No.: US 2026/0349081 A1
(43) Pub. Date: Nov. 5, 2026

(54) LIDAR AND VEHICLE

(71) Applicant: AUTOX TECH PTE. LTD., SINGAPORE (SG)

(72) Inventors: Zhenkun Wang, Shenzhen (CN); Kefan Hu, Shenzhen (CN); Yanan Zhi, Shenzhen (CN); Jianxiong Xiao, Shenzhen (CN); Yizhou Shan, Shenzhen (CN); Xuhui Tao, Shenzhen (CN)

(73) Assignee: AUTOX TECH PTE. LTD., SINGAPORE (SG)

(21) Appl. No.: 19/193,975

(22) Filed: Apr. 30, 2025

(51) Int. Cl. G01S 7/481; G01S 17/88

(52) U.S. Cl. CPC G01S 7/4817; G01S 7/4814; G01S 7/4818; G01S 17/88

(57) ABSTRACT

The disclosure provides a lidar and a vehicle, including a laser light source, a collimator, a rotating mechanism, and a derotating mechanism. The collimator and the derotating mechanism are sequentially arranged on an optical path of light emitted from the laser light source, the collimator includes an input port and an output port, the collimator receives the light emitted from the laser light source via the input port, forms the light into a plurality of light beams with angles between each other, which then emitted to the derotating mechanism through the output port, the derotating mechanism includes a derotating prism and a first reflective mirror; the rotating mechanism is configured to drive the derotating prism and the first reflective mirror in differential rotations to eliminate image rotation, the plurality of light beams sequentially pass through the derotating prism and the first reflective mirror.

### TECHNICAL FIELD

The present invention relates to the field of laser scanning technology, particularly to a lidar and a vehicle.

### BACKGROUND

Existing lidars mostly adopt mechanical rotation and linear transceiver arrangements. This scanning method requires precise alignment of the optical modules for each channel. Crosstalk between different ranging channels demands high-level assembly precision. Additionally, the lidars are characterized by large size, high rotational inertia, high power consumption, and high costs, along with stringent requirements for heat dissipation and manufacturing processes. Furthermore, newer technologies employ 45-degree rotating mirror scanning methods, such as those disclosed in patent documents CN107643525A and CN209858727U. However, this design still limits the vertical field-of-view due to the radial size of prisms. Increasing the radial size of the prisms to enlarge the vertical field-of-view makes the lidars bulky.

### SUMMARY

Disclosed are a lidar and a vehicle, wherein the lidar, compact in size, achieves to scan 360 degrees horizontally and a certain vertical range.

In a first aspect, the lidar provided includes a laser light source, a collimator, a rotating mechanism, and a derotating mechanism The collimator and the derotating mechanism are sequentially arranged on an optical path of light emitted from the laser light source. The collimator includes an input port and an output port. The laser light source is arranged on a side of the input port, and the derotating mechanism is arranged on a side of the output port. The collimator, receiving the light emitted from the laser light source via the input port, forms the light into a plurality of light beams with angles between each other, which are then emitted to the derotating mechanism through the output port. The derotating mechanism includes a derotating prism and a first reflective mirror. The rotating mechanism, fixedly connected to the derotating prism and the first reflective mirror, is configured to drive the derotating prism and the first reflective mirror in differential rotations to eliminate image rotation. The plurality of light beams sequentially pass through the derotating prism and the first reflective mirror.

Preferably, the collimator includes a first lens, a second lens, and a third lens. The first lens is equipped with the output port. The third lens is equipped with the input port. The first lens is a double-convex lens. The second lens and the third lens are convex lenses, with convex surfaces of both facing towards the first lens. Focal points of the first lens, the second lens, and the third lens are located on a same straight line.

Preferably, optical performance of the collimator includes total optical length, field of view, total lens length, and exit pupil distance. The total optical length is 60-65 mm. The total lens length is 52-57 mm. The field of view is 20-60 degrees. The total optical length is equal to the exit pupil distance.

Preferably, the derotating prism is equipped with a light output surface and a central line. The first reflective mirror includes a reflective surface. The reflective surface and the light output surface are placed at an angle of 45 degrees to each other. The first reflective mirror and the derotating prism rotate around the central line driven by the rotating mechanism.

Preferably, the laser light source includes a plurality of optical fibers, an optical switch, and a plurality of lasers. The optical switch includes a plurality of light output ports and a plurality of light input ports. The plurality of optical fibers are located at the plurality of light input ports. The plurality of lasers are located at the plurality of light output ports. A number of the plurality of light output ports is consistent with a number of the plurality of lasers. A number of the plurality of light input ports is consistent with a number of the plurality of optical fibers.

Preferably, the collimator is a multi-channel collimator. The multi-channel collimator includes a plurality of optical path channels. A number of the plurality of optical path channels is consistent with the number of the plurality of lasers. The plurality of optical path channels are configured to collimate the light into parallel beams of multiple fields of view simultaneously.

Preferably, the rotational angular velocity of the first reflective mirror is twice the rotational angular velocity of the derotating prism.

Preferably, the lidar further includes a second reflective mirror. The second reflective mirror and the first reflective mirror are arranged in parallel. The second reflective mirror is located on the optical path between the derotating mechanism and the laser light source, and is configured to refract the light.

Preferably, the derotating prism includes a Dove prism or a Bihan prism.

In a second aspect, the vehicle provided includes a lidar and a vehicle body. The lidar includes a laser light source, a collimator, a rotating mechanism, and a derotating mechanism The collimator and the derotating mechanism are sequentially arranged on an optical path of light emitted from the laser light source. The collimator includes an input port and an output port. The laser light source is arranged on a side of the input port, and the derotating mechanism is arranged on a side of the output port. The collimator, receiving the light emitted from the laser light source via the input port, forms the light into a plurality of light beams with angles between each other, which are then emitted to the derotating mechanism through the output port. The derotating mechanism includes a derotating prism and a first reflective mirror. The rotating mechanism, fixedly connected to the derotating prism and the first reflective mirror, is configured to drive the derotating prism and the first reflective mirror in differential rotations to eliminate image rotation. The plurality of light beams sequentially pass through the derotating prism and the first reflective mirror. The vehicle body includes a roof. The lidar is arranged on the roof. The lidar is configured to scan objects around the vehicle.

The aforementioned lidar and vehicle achieve a scanning area with a vertical angle of 30 degrees and a panoramic angle of 360 degrees through the cooperation of the laser light source, collimator, rotating mechanism, and derotator. Specifically, the laser light source achieves vertical field of view coverage through multiple optical path channels of the collimator; that is, each light beam of light emitted from the laser light source forms an approximately parallel beam after passing through the corresponding optical path channel, and different parallel beams form certain angles between each other through different optical path channels, thereby forming vertical angles. On the other hand, rotating the rotating mechanism and the derotator at different speeds can achieve the effect of eliminating image rotation and 360 degrees panoramic scanning.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a schematic diagram of a lidar provided in a first embodiment.

FIG. 2 illustrates a schematic diagram of a lidar provided in a second embodiment.

FIG. 3 illustrates a schematic diagram of a combination of a laser light source and a collimator.

FIG. 4 illustrates a diagram of an optical path flow.

FIG. 5 illustrates a schematic diagram of a vehicle.

The realization of the purpose, functional characteristics and advantages of the disclosure will be further explained by referring to the attached drawings.

### DETAILED DESCRIPTION OF THE EMBODIMENTS

In order to make the purpose, technical solution and advantages of the invention more clearly, the invention is further described in detail in combination with the drawings and embodiments. It is understood that the specific embodiments described herein are used only to explain the invention and are not configured to define it. On the basis of the embodiments in the invention, all other embodiments obtained by ordinary technicians in this field without any creative effort are covered by the protection of the invention.

The terms “first”, “second”, “third”, “fourth”, if any, in the specification, claims and drawings of this application are configured to distinguish similar objects but need not be configured to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the invention are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the invention.

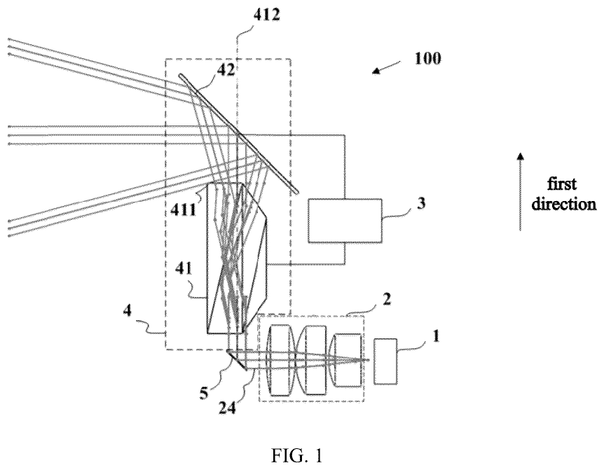

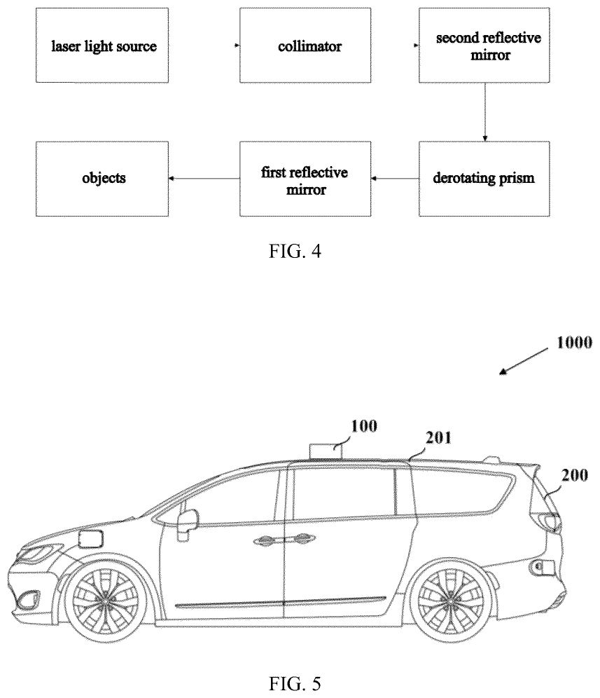

Referring to FIG. 1 and FIG. 4, a schematic diagram of a lidar provided in a first embodiment is illustrated in FIG. 1, a diagram of an optical path flow is illustrated in FIG. 4.

A lidar 100 includes a laser light source 1, a collimator 2, a rotating mechanism 3, and a derotation mechanism 4. The laser light source 1, the collimator 2, and the derotation mechanism 3 are sequentially arranged in a first direction. The collimator 2 and the derotation mechanism 4 are sequentially arranged on an optical path of light emitted from the laser light source 1. The light emitted from the laser light source 1, after passing through the collimator 2, forms a plurality of parallel beams directed towards the derotation mechanism 4. The rotating mechanism 3 drives the derotation mechanism 4 to rotate, enabling the lidar 100 to eliminate image rotation and allowing plurality of parallel beams to scan 360 degrees around.

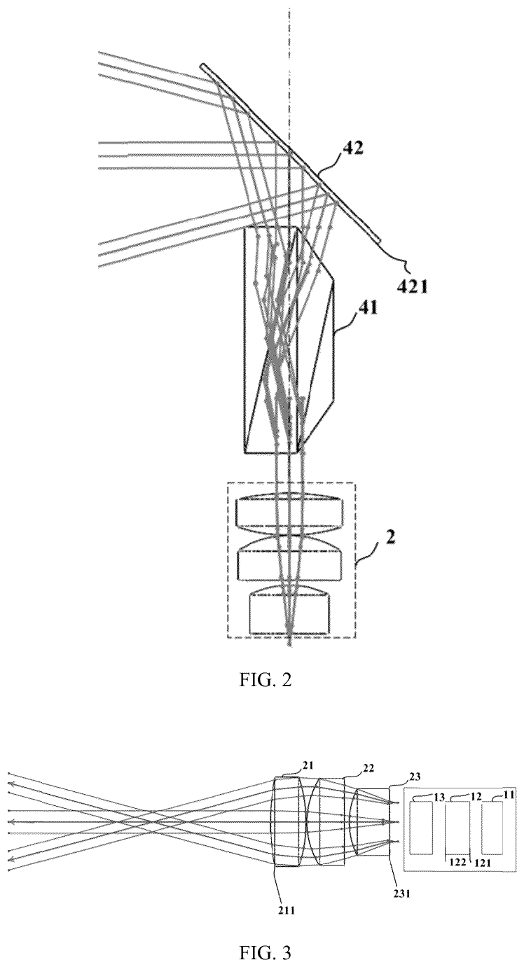

Referring to FIG. 2, a schematic diagram of a lidar provided in a second embodiment is illustrated in FIG. 2.

Specifically, the lidar 100 further includes a second reflective mirror 5. The second reflective mirror 5 and the first reflective mirror 42 are arranged in parallel. The second reflective mirror 5 is located on the optical path between the derotation mechanism 4 and the laser light source 1, and is configured to refract the light.

Specifically, in the second embodiment, three light sources are arranged in parallel, but they can also be arranged at a certain angle. Regardless of whether they are a series of lasers or a series of optical fibers, they can be regarded as an array of laser light sources 1 that can independently emit light. The light beams emitted from the laser light source 1 array are divergent. The transmission distance of the light beams emitted from the laser light source 1 is very short.

Specifically, the collimator 2 includes an input port 211 and an output port 231. The laser light source 1 is arranged on a side near the input port 211, and the derotation mechanism 4 is arranged on a side near the output port 231. The collimator 2 is configured to receive the light emitted from the laser light source 1, and form a plurality of light beams with angles between each other, which are then emitted to the derotation mechanism 4 through the output port 231.

Specifically, the derotation mechanism 4 includes a derotation prism 41 and a first reflective mirror 42. The rotating mechanism 3, fixedly connected to the derotation prism 41 and the first reflective mirror 42, is configured to drive both in differential rotations to eliminate image rotation. The plurality of light beams sequentially pass through the derotation prism 41 and the first reflective mirror 42.

As described, the light emitted from the laser light source 1 is collimated by the collimator 2 into a plurality of angled parallel beams. The angled parallel beams pass through depolarizer 4, which is rotated by rotating mechanism 3. This rotation enables the lidar to eliminate image rotation and perform a 360-degree scan. The lidar 100 mentioned-above replaces a traditional upper-and-lower-compartment structure of a multi-line lidar, reduces collimator elements, and suits different application scenarios of various lidars, which including non-coherent and coherent detection. Meanwhile, compared to existing 45-degree rotating mirror lidarr, it uses a specialized collimator 2. This collimator 2 enlarges the vertical field-of-view without complicating the structure, thus avoiding increased assembly difficulty. The lidar 100 mentioned-above offers a simple structure, high reliability, easy assembly, integrability, miniaturization, no fast-axis scanning, and low moment of inertia, showing great promise in a field of automotive lidar.

Referring to FIG. 3, a schematic diagram of a combination of a laser light source and a collimator is illustrated in FIG. 3.

The laser light source 1 includes a plurality of optical fibers 11, an optical switch 12, and a plurality of lasers 13. The optical switch 12 includes a plurality of light output ports 122 and a plurality of light input ports 121. The plurality of optical fibers 11 are located at the plurality of light input ports 121, and the plurality of lasers 13 are located at the plurality of light output ports 122. A number of the plurality of light outlet ports 122 is consistent with a number of the plurality of lasers 13. A number of the plurality of light input ports 121 is consistent with a number of the plurality of optical fibers 11.

Specifically, the optical fiber 11 is connected to the optical switch 12 and then to the laser 13. The advantage of the optical fiber 11 in conjunction with the optical switch 12 is to reduce the number of lasers 13. For example, 12-line emission can be achieved by 3 lasers and 4 controllable 4-line optical switches.

As described, the laser light source 1, which employs the plurality of optical fibers 11, the optical switch 12, and the plurality of lasers 13, can reduce the number of lasers 13 to a certain extent, thereby reducing the occupied space and lowering production costs.

The collimator 2 includes a first lens 21, a second lens 22, and a third lens 23. The first lens 21 is equipped with the output port 231. The third lens 23 is equipped with the input port 211. The first lens 21 is a double-convex lens, while the second lens 22 and the third lens 23 are convex lenses, with convex surfaces of the second lens 22 and the third lens 23 facing toward the first lens 21. Focal points of the first lens 21, the second lens 22, and the third lens 23 are located on a same straight line.

Specifically, the third lens 23 is the convex lens. When the light enters a plane of the third lens 23 and exits from the convex surface of the third lens 23, the light diverges into a beam with field-of-view width. The second lens 22 further expands the width, and the first lens 21 then flattens the beam into a scanning beam with vertical angular width. For example, taking horizontal left as the 0° direction, light from a first source is collimated to point at −15 degrees, and that from a third source at +15 degrees, achieving a 30-degree vertical field-of-view.

Specifically, optical performance of the collimator 2 includes total optical length, field of view, total lens length, and exit pupil distance. The total optical length is 60-65 mm, the total lens length is 52-57 mm, the field of view range is 20-60 degrees, and the total optical length is equal to the exit pupil distance.

Specifically, the collimator 2 is of a telecentric system in object space. The multi-channel collimator 2 includes a plurality of optical path channels 24, a number of which is consistent with the number of the plurality of lasers 13. The plurality of optical path channels 24 are configured to collimate the light into parallel beams of multiple fields of view simultaneously. The exit pupil of the collimator 2 is located in a image space, with a relatively large exit pupil distance.

As described, the collimator 2 serves two main functions. The first function is to provide the plurality of optical path channels 24, which convert the light into a nearly-parallel light. The second function is to refract the plurality of parallel beams at a certain angle to form a scanning plane with a certain vertical width. These two functions expand a scanning range of the light emitted from the laser light source 1 in a vertical direction, meeting the requirement of achieving vehicle-mounted radar scanning with minimal spatial adjustment.

The derotator prism 41 is equipped with a light output surface 411 and a center line 412. The first reflective mirror 42 includes a reflective surface 421. The reflective surface 421 and the light output surface 411 are placed at an angle of 45 degrees to each other. The centerline 412 is parallel to the first direction. The first reflective mirror 42 and the derotator prism 41 rotate around the centerline 412 driven by the rotating mechanism 3.

Specifically, the derotator prism 41 comprises a Dove prism or a Berek prism.

Specifically, the rotational angular velocity of the first reflective mirror 42 is twice the rotational angular velocity of the derotator prism 41.

As described, taking the Dove prism as an example, the collimated light from the collimator 2 is reflected by the second reflective mirror 5 placed at 45 degrees before entering the Dove prism, where it undergoes refraction on a first waist surface, reflection on a lower base surface, and refraction on a second waist surface in sequence, and then exits through the first reflective mirror 42 placed at 45 degrees, covering a vertical field of view angle of 30 degrees. Herein, the Dove prism and the first reflective mirror 42 rotate around a vertical rotation axis. The angular velocity of the first reflective mirror 42 is twice that of the Dove prism to eliminate image rotation.

Specifically, the lidar 100 further includes a signal receiving component for receiving the reflected light signals.

Referring to FIG. 5, a schematic diagram of a vehicle is illustrated in FIG. 5.

A vehicle provided includes the lidar 100 and a vehicle body 200. The vehicle body 200 includes a roof 201. The lidar 100 is mounted on the roof 201. The lidar 100 adopts the lidar 100 described above, sharing the same advantages and disadvantages, which are not redundantly described here.

In the above embodiments, the lidar and vehicle achieve a scanning area with a vertical angle of 30 degrees and a panoramic angle of 360 degrees through the cooperation of the laser light source, collimator, rotating mechanism, and derotator. Specifically, the laser light source achieves vertical field of view coverage through multiple optical path channels of the collimator; that is, each light beam of light emitted from the laser light source forms an approximately parallel beam after passing through the corresponding optical path channel, and different parallel beams form certain angles between each other through different optical path channels, thereby forming vertical angles. On the other hand, rotating the rotating mechanism and the derotator at different speeds can achieve the effect of eliminating image rotation and 360 degrees panoramic scanning.

The above disclosed preferred embodiments of the invention are intended only to assist in the elaboration of the invention. The preferred embodiment does not elaborate on all the details and does not limit the invention to a specific embodiment. Obviously, according to the contents of this instruction manual, a lot of amendments and changes can be made. These embodiments are selected and described in detail in this specification for the purpose of better explaining the principle and practical application of the invention, so that the technical personnel in the technical field can better understand and utilize the invention. The invention is limited only by the claims and their full scope and equivalents.

The above are only the preferred embodiments of this invention and do not therefore limit the patent scope of this invention. And equivalent structure or equivalent process transformation made by the specification and the drawings of this invention, either directly or indirectly applied in other related technical fields, shall be similarly included in the patent protection scope of this invention.

1. A lidar, the lidar comprising a laser light source, a collimator, a rotating mechanism, and a derotating mechanism; the collimator and the derotating mechanism being sequentially arranged on an optical path of light emitted from the laser light source; the collimator comprising an input port and an output port, the laser light source being arranged on a side of the input port, and the derotating mechanism being arranged on a side of the output port; the collimator, receiving the light emitted from the laser light source via the input port, forming the light into a plurality of light beams with angles between each other, which being then emitted to the derotating mechanism through the output port; the derotating mechanism comprising a derotating prism and a first reflective mirror; the rotating mechanism, fixedly connected to the derotating prism and the first reflective mirror, being configured to drive the derotating prism and the first reflective mirror in differential rotations to eliminate image rotation, the plurality of light beams sequentially passing through the derotating prism and the first reflective mirror.

2. The lidar according to claim 1, wherein the collimator comprises a first lens, a second lens, and a third lens; the first lens is equipped with the output port, the third lens is equipped with the input port; the first lens is a double-convex lens, the second lens and the third lens are convex lenses, with convex surfaces of both facing towards the first lens; focal points of the first lens, the second lens, and the third lens are located on a same straight line.

3. The lidar according to claim 1, wherein optical performance of the collimator comprises total optical length, field of view, total lens length, and exit pupil distance.

4. The lidar according to claim 3, wherein the total optical length is 60-65 mm, the total lens length is 52-57 mm, the field of view is 20-60 degrees, the total optical length is equal to the exit pupil distance.

5. The lidar according to claim 1, wherein the derotating prism is equipped with a light output surface and a central line, the first reflective mirror comprises a reflective surface; the reflective surface and the light output surface are placed at an angle of 45 degrees to each other; the first reflective mirror and the derotating prism rotate around the central line driven by the rotating mechanism.

6. The lidar according to claim 1, wherein the laser light source comprises a plurality of optical fibers, an optical switch, and a plurality of lasers; the optical switch comprises a plurality of light output ports and a plurality of light input ports; the plurality of optical fibers are located at the plurality of light input ports, the plurality of lasers are located at the plurality of light output ports; a number of the plurality of light output ports is consistent with a number of the plurality of lasers, and a number of the plurality of light input ports is consistent with a number of the plurality of optical fibers.

7. The lidar according to claim 5, wherein the collimator is a multi-channel collimator; the multi-channel collimator comprises a plurality of optical path channels; a number of the plurality of optical path channels is consistent with the number of the plurality of lasers, the plurality of optical path channels are configured to collimate the light into parallel beams of multiple fields of view simultaneously.

8. The lidar according to claim 1, wherein the rotational angular velocity of the first reflective mirror is twice the rotational angular velocity of the derotating prism.

9. The lidar according to claim 1, wherein the lidar further comprises a second reflective mirror; the second reflective mirror and the first reflective mirror are arranged in parallel; the second reflective mirror is located on the optical path between the derotating mechanism and the laser light source, and is configured to refract the light.

10. The lidar according to claim 1, wherein the derotating prism comprises a Dove prism or a Bihan prism.

11. A vehicle, the vehicle comprising a lidar and a vehicle body, the lidar comprising a laser light source, a collimator, a rotating mechanism, and a derotating mechanism; the collimator and the derotating mechanism being sequentially arranged on an optical path of light emitted from the laser light source; the collimator comprising an input port and an output port, the laser light source being arranged on a side of the input port, and the derotating mechanism being arranged on a side of the output port; the collimator, receiving the light emitted from the laser light source via the input port, forming the light into a plurality of light beams with angles between each other, which are then emitted to the derotating mechanism through the output port; the derotating mechanism comprising a derotating prism and a first reflective mirror; the rotating mechanism, fixedly connected to the derotating prism and the first reflective mirror, being configured to drive the derotating prism and the first reflective mirror in differential rotations to eliminate image rotation, the plurality of light beams sequentially passing through the derotating prism and the first reflective mirror;
the vehicle body comprising a roof; the lidar being arranged on the roof, the lidar being configured to scan objects around the vehicle.

12. The vehicle according to claim 11, wherein the collimator comprises a first lens, a second lens, and a third lens; the first lens is equipped with the output port, the third lens is equipped with the input port; the first lens is a double-convex lens, the second lens and the third lens are convex lenses, with convex surfaces of both facing towards the first lens; focal points of the first lens, the second lens, and the third lens are located on a same straight line.

13. The vehicle according to claim 11, wherein optical performance of the collimator comprises total optical length, field of view, total lens length, and exit pupil distance.

14. The vehicle according to claim 13, wherein the total optical length is 60-65 mm, the total lens length is 52-57 mm, the field of view is 20-60 degrees, the total optical length is equal to the exit pupil distance.

15. The vehicle according to claim 11, wherein the derotating prism is equipped with a light output surface and a central line, the first reflective mirror comprises a reflective surface; the reflective surface and the light output surface are placed at an angle of 45 degrees to each other; the first reflective mirror and the derotating prism rotate around the central line driven by the rotating mechanism.

16. The vehicle according to claim 11, wherein the laser light source comprises a plurality of optical fibers, an optical switch, and a plurality of lasers; the optical switch comprises a plurality of light output ports and a plurality of light input ports; the plurality of optical fibers are located at the plurality of light input ports, the plurality of lasers are located at the plurality of light output ports; a number of the plurality of light output ports is consistent with a number of the plurality of lasers, and a number of the plurality of light input ports is consistent with a number of the plurality of optical fibers.

17. The vehicle according to claim 15, wherein the collimator is a multi-channel collimator; the multi-channel collimator comprises a plurality of optical path channels; a number of the plurality of optical path channels is consistent with the number of the plurality of lasers, the plurality of optical path channels are configured to collimate the light into parallel beams of multiple fields of view simultaneously.

18. The vehicle according to claim 11, wherein the rotational angular velocity of the first reflective mirror is twice the rotational angular velocity of the derotating prism.

19. The vehicle according to claim 11, wherein the lidar further comprises a second reflective mirror; the second reflective mirror and the first reflective mirror are arranged in parallel; the second reflective mirror is located on the optical path between the derotating mechanism and the laser light source, and is configured to refract the light.

20. The vehicle according to claim 11, wherein the derotating prism comprises a Dove prism or a Bihan prism.
